(19) United States
(12) Patent Application Publication
(10) Pub. No.: US 2019/0005471 A1
(43) Pub. Date: Jan. 3, 2019

(54) METHOD OF OPERATING AND USING A CRYPTOCURRENCY

(71) Applicant: Kitaru Innovations Inc., Warrens (BB)

(72) Inventor: Kapoor Chandaria, Nairobi (KE)

(21) Appl. No.: 16/018,147

(22) Filed: Jun. 26, 2018

Related U.S. Application Data
(60) Provisional application No. 62/526,123, filed on Jun. 28, 2017.

(51) Int. Cl. G06Q 20/06; G06Q 20/22; G06Q 20/38; G06Q 40/04; G06Q 40/00

(52) U.S. Cl. CPC G06Q 20/065; G06Q 20/223; G06Q 50/02; G06Q 40/04; G06Q 40/10; G06Q 20/381

(57) ABSTRACT

A method of donating to a charity (or paying for goods and services) utilizing a cryptocurrency secured with real world assets. The assets may be gold assets, particularly those currently buried in the ground. The buried gold's value is verified by an independent third party and a value of a unit of the cryptocurrency is assigned based on the verification. A user then donates a quantity of cryptocurrency units to a non-profit or charity. The charity issues a tax deduction receipt and the donor presents the receipt to a tax collection office and applies a tax deduction to their income tax. Through the donation the charity gains a share in the buried gold assets. The charity may sell or hold onto their share or hold on to the share until the gold is mined, processed, and sold. The realized money can then be used by the charity.

### CROSS-REFERENCE TO RELATED APPLICATIONS

This application claims the benefit of U.S. Provisional Patent Application Ser. No. 62/526,123, filed Jun. 28, 2017, the entire disclosure of which is incorporated herein by reference.

### BACKGROUND

### Technical Field

This disclosure is related generally to cryptocurrency. More particularly, this disclosure relates to cryptocurrency that is backed by real world physical assets and not by theoretical assets on the Internet. Specifically, this disclosure relates to a new cryptocurrency that is backed by gold; particularly gold that is still in the ground and that is yet to be physically extracted from the ground and to a method of donating units of this cryptocurrency to a charity.

### Background Information

Digital currencies or electronic currencies do not involve physical banknotes or coins but instead rely on electronic financial transactions between parties. These transactions may occur over the Internet or on mobile devices and may be utilized to pay for real or virtual goods and services. Digital currencies allow for substantially instantaneous transactions between parties. Additionally, digital currencies can be sent anywhere around the world and are not bound by borders between countries.

Cryptocurrencies are a subset of digital currencies that are encrypted so as to safeguard personal details of the user. As such, cryptocurrencies may be safer than physical financial transactions or other types of digital financial transactions.

At present, there are a number of different cryptocurrencies in use on the Internet such as Bitcoin and ETHEREUM® (ETHEREUM® is a registered trademark of Gene Riccoboni of Brewster, N.Y., USA. One of the most widely used cryptocurrencies is Bitcoin. Bitcoin is a peer to peer (P2P) currency system and the currency units are not associated with any physical commodity. Furthermore, the currency is not regulated or otherwise controlled by any government or any bank. Bitcoin units, which are known as bitcoin, have value because people on the Internet ascribe value to the bitcoin but the cryptocurrency actually has no physical attributes or assets that back it. Consequently, this cryptocurrency, like other cryptocurrencies is volatile in price and somewhat unstable. Because of this instability, there has been some reluctance on a part of merchants and vendors to accept bitcoin as payment for goods and services they provide.

Paper money, coins, stocks and bonds, and other physical forms of payment, on the other hand are backed by real-world physical assets and are therefore more stable in value.

### SUMMARY

However, as things in the world become ever more electronic and much of life is transacted on the Internet, there is a need for a stable digital currency that will tend to maintain its value in much the same way as physical currency.

The present disclosure is directed to a cryptocurrency (i.e., a currency traded entirely on the internet) that is backed by real world physical assets. The real world, physical assets assure the value and stability of this new cryptocurrency.

In one aspect, the present disclosure may provide a method of making a donation to a charity comprising steps of providing a cryptocurrency; and backing the cryptocurrency with real world assets. The step of backing includes backing the cryptocurrency with a publically traded commodity. The step of backing may include backing the cryptocurrency with a precious metal asset. The step of backing the cryptocurrency with a precious metal asset includes backing the cryptocurrency with gold assets. The step of backing the cryptocurrency with gold assets includes backing the cryptocurrency with gold that is not yet mined and is currently buried underground. The method may further include verifying a value of the buried gold. The step of verifying includes using an independent third party to independently verify the value the buried gold. The method further comprises assigning a value to a unit of the cryptocurrency based on the independent verification of the value of the buried gold.

In another aspect, the present disclosure may provide a method that further includes donating a quantity of units of the cryptocurrency to one of a non-profit organization or a charitable organization. The method may further include issuing, by the non-profit organization or the charitable organization, a tax deduction receipt for the donated units of cryptocurrency. The method may further comprise presenting, by a donor of the units of cryptocurrency, the tax deduction receipt to a tax collection office of a national government of the donor. The method may further comprise applying a tax deduction provided by the tax deduction receipt to the donor's income tax.

In another aspect, the present disclosure may provide a method that includes gaining, on a part of the non-profit organization or the charitable organization, a share in the buried gold assets. The method may further comprise determining the share in the buried gold assets based on the quantity of units of cryptocurrency donated to the non-profit organization or the charitable organization. The method may further comprise selling the non-profit organization's share or the charitable organization's share of the buried gold assets. The method may further include utilizing proceeds of a sale of the non-profit organization's share or the charitable organization's share of the buried gold assets for work performed by the non-profit organization or the charitable organization.

In yet another aspect, the present disclosure may provide a method that includes mining and processing the gold; selling the mined and processed gold; realizing a profit from the sold processed gold; taking the non-profit organization's share or the charitable organization's share of the profit; and utilizing the non-profit organization's share or the charitable organization's share of the profit for work performed by the non-profit organization or the charitable organization.

In another aspect the present disclosure may provide a method of paying for a good or service comprising purchasing a good or a service from one of a business and an organization; providing a cryptocurrency; backing the cryptocurrency with real world assets; and paying the business or the organization for the purchase good or purchase service utilizing a quantity of units of the cryptocurrency. The step of backing includes backing the cryptocurrency with a publically traded commodity. The step of backing includes backing the cryptocurrency with a precious metal asset. The step of backing the cryptocurrency with a precious metal asset includes backing the cryptocurrency with gold assets. The step of backing the cryptocurrency with gold assets includes backing the cryptocurrency with gold that is not yet mined and is currently buried underground. The method may further comprise verifying a value of the buried gold. The step of verifying includes using an independent third party to independently verify the value the buried gold. The method may further comprise assigning a value to a unit of the cryptocurrency based on the independent verification of the value of the buried gold. Still further, the method may comprise gaining, on a part of the business or the organization, a share in the buried gold assets. The method may further comprise determining the share in the buried gold assets based on the quantity of units of cryptocurrency paid to the business or the organization.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a flow chart showing use of a PRIOR ART cryptocurrency for making charitable donations;

FIG. 2 is a diagrammatic view of a system utilizing a real world-physical asset backed cryptocurrency in accordance with the present disclosure;

FIG. 3 is a flow chart showing a system for assigning a value to a unit of the cryptocurrency used in the system of FIG. 2; and

FIG. 4 is a flow chart showing a method of using the real world, physical-asset backed cryptocurrency in accordance with the present disclosure to make a charitable donation.

Similar numbers refer to similar parts throughout the drawings.

### DETAILED DESCRIPTION

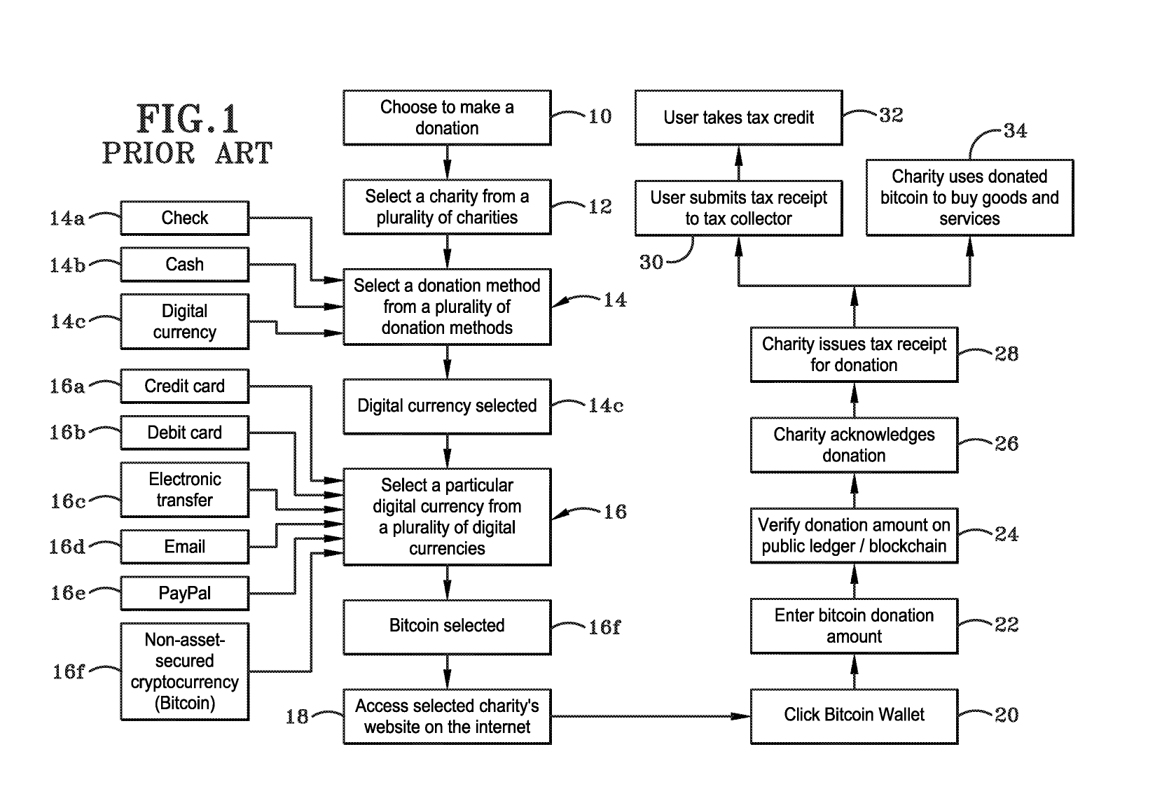

FIG. 1 shows a PRIOR ART method for using a PRIOR ART cryptocurrency, such as Bitcoin to make a charitable donation.

In this PRIOR ART method in a first step 10 a user (or donor) decides to make a charitable donation. In a second step 12, the user selects a single charity from a plurality of possible charities. In a third step 14, the user then selects a donation method from a plurality of possible donation methods. The plurality of donation methods may include but is not limited to, sending a paper check 14a, donating cash 14b, and using a digital currency 14c donated over the Internet. In the illustrated example, the user selects the donation method that involves utilizing a digital currency 14c to make the donation.

In a next step 16, the user selects a particular digital currency from a plurality of digital currencies. The plurality of digital currencies may include but is not limited to making a credit card donation 16a, making a debit card donation 16b, transferring money electronically from a bank checking or savings account 16c, making an email transfer 16d, using PayPal® or similar non-encrypted digital currencies 16e, or selecting a non-asset-secured cryptocurrency such as Bitcoin 16f. In the illustrated method, the user selects to donate to the selected charity using Bitcoin 16f.

The user will then, in a next step 18, access the charity's website and will click on a Bitcoin wallet icon 20 displayed on the website. In a next step, the amount of the donation will then be entered into the Bitcoin wallet 22. In particular, the quantity of bitcoin to be donated will be entered into the Bitcoin wallet 22. Once the donation has been made in the aforementioned fashion, the bitcoin transfer is verified using the public ledger and blockchain that forms part of the Bitcoin system. This step is identified in FIG. 1 by the reference number 24.

Once the transaction is verified in step 24, the charity's website will acknowledge the donation 26 and will issue a tax receipt 28. The tax receipt 28 may be generated and made immediately available to the user or may be emailed or mailed to the user.

In a next step 30, the user will present their tax receipt to their income tax collection authority 131 with a tax return and will take a tax deduction from their income 32.

In a further step 34, the charity will use the donated amount of bitcoin to purchase goods and services from vendors who accept Bitcoin.

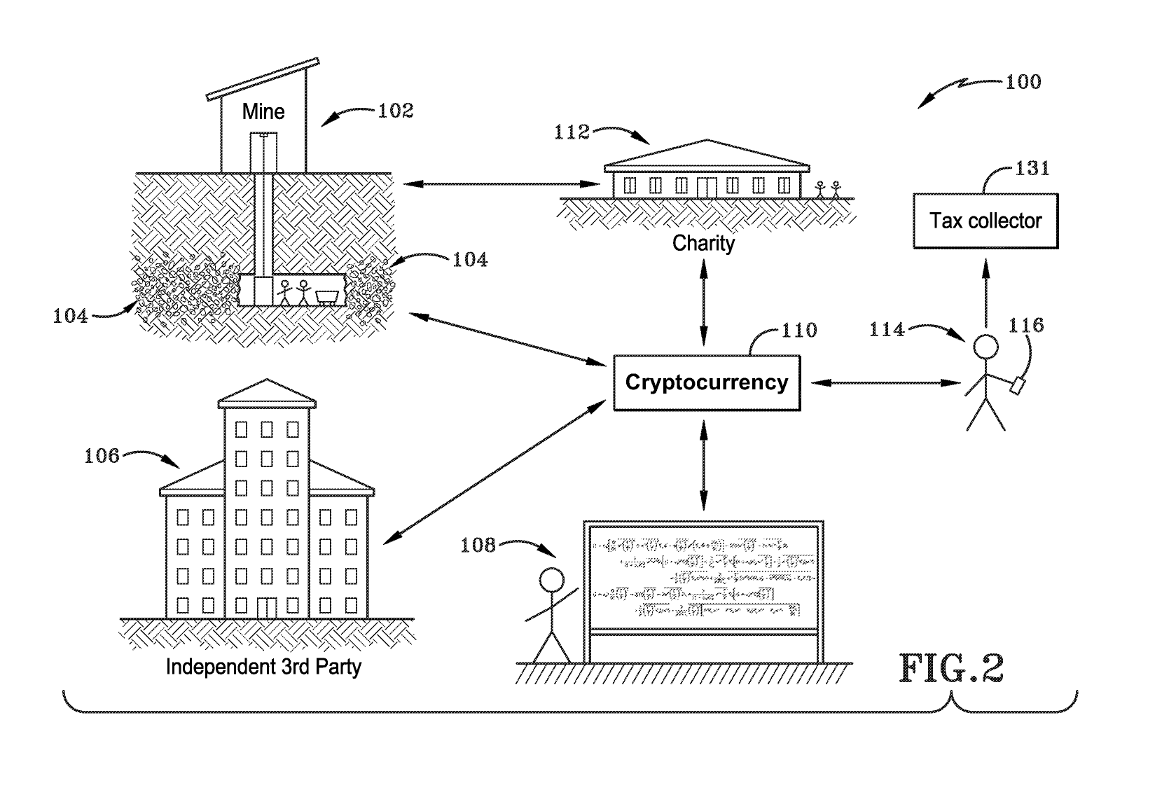

FIGS. 2-4 illustrate an alternative system 100 for making donations to charities in accordance with the present disclosure. The system 100 includes a physical asset 102 or real world asset 102 in the form of one or more mines for precious metals. In other examples, the physical real world asset may be a publically traded commodity, particularly a precious metal asset such as gold assets, silver assets, diamonds, platinum assets, oil assets or gas assets, or any other valuable assets, particularly those that have to be extracted from the earth. In particular, the real world, physical asset 102 may be one or more gold mines. The gold mines are actual, physical, and real gold mines. Most particularly, the asset in question is a quantity of gold 104 at the one or more gold mines and this gold 104 has not yet been extracted from the ground (i.e., has yet to be mined). As such, the gold is buried in the ground. It will be understood that the term “gold” or “gold assets” or “gold mines” utilized herein are to be considered exemplary of the type of real world valuable physical assets that may be utilized to back the new cryptocurrency but the terms should not be considered to limit the current disclosure to only that particular metal or asset or mine.

Gold 104 that is yet unmined and remains buried in the ground may be regarded as having a first value that approximates US$140 per ounce as of the date of writing this description. Gold that is already mined and processed currently trades at about US1245 per ounce. In other words the mining and processing of gold adds around $1200 to the value of one ounce of gold. The real-world physical asset 102 that is utilized in system 100 however is a quantity of gold 104 that has a value of around US$140 per ounce in today's prices.

System 100 further comprises an independent third party 106 who is qualified to assess the quantity of buried gold 104 at the one or more mines and to assess the value of those buried gold reserves. The independent third party 106 therefore verifies the value of the asset 102. The independent third party 106 is at least one of an individual person (who is qualified to make this valuation and has no personal interest or assets in the gold mine or the quantity of gold reserves in question), a mining company, a prospecting company or any other organization that is qualified to make this valuation but has no interest or assets in the gold mine or quantity of gold reserves at the gold mine in question, or a state or government agency (who is qualified to make this valuation) who has no interest or assets in the gold mine or the quantity of gold reserves at the gold mine in question. In other words, the third party is a neutral party with no interest or stake in the assets that back the cryptocurrency.

It will be understood that while gold has been selected as the commodity of value to back a new cryptocurrency 110, any other precious commodity may be used as the assets to back the new cryptocurrency 110.

System 100 further comprises a person or entity 108 who is the developer and/or administrator of the new cryptocurrency 110. The cryptocurrency 110 is an asset-secured cryptocurrency; where the assets in question are the verified quantity and value of the buried gold 104 at the one or more gold mines 102.

Cryptocurrency 110 may be made accessible to people all over the world via the Internet. Because cryptocurrency 110 is asset-secured in the real world, the cryptocurrency 110 should be less volatile and prone to value swings than other non-asset-secured cryptocurrencies like Bitcoin or Ethereum. Cryptocurrency 110 may also be a convertible cryptocurrency that may be converted to or from state-issued currencies such as the US or Canadian Dollar, for example.

One of the potential uses for cryptocurrency 110 is the use thereof for charitable donations. System 100 may therefore also include a plurality of charitable institutions or non-profit organizations, generally indicated in FIG. 2 by the reference number 112. Finally, system 110 may include a user (or donor) 114 who may wish to make a charitable contribution or donation to one or more charities 112. The user 114 may have access to the Internet and therefore to the cryptocurrency 110 utilizing a computing device 116 such as a mobile device, a computer, a tablet etc.

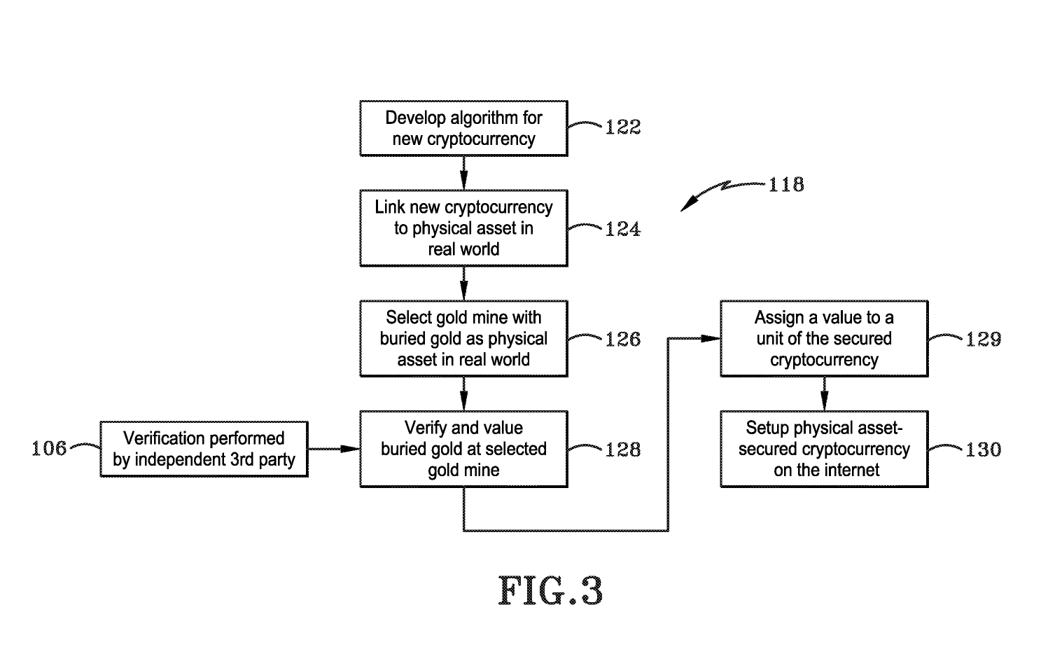

FIG. 3 shows a method for developing the real-world asset-backed cryptocurrency 110. The method is identified by the reference number 118. In a first step 120, an algorithm 122 for the new cryptocurrency is developed. In a second step 124, the cryptocurrency is linked to a physical asset in the real world. As discussed above, the real world physical asset 102 is a gold mine having gold deposits 104 buried in the ground. The method 118 includes a next step 126 of selecting one or more gold mines to back/secure cryptocurrency 110. In a next step 128 the value of the gold deposits 104 at the selected one or more gold mines 102 is assessed and verified by independent third party 106. Once asset 102 is verified, the asset-backed cryptocurrency 110 is launched on the Internet. This step is indicated by the reference number 130.

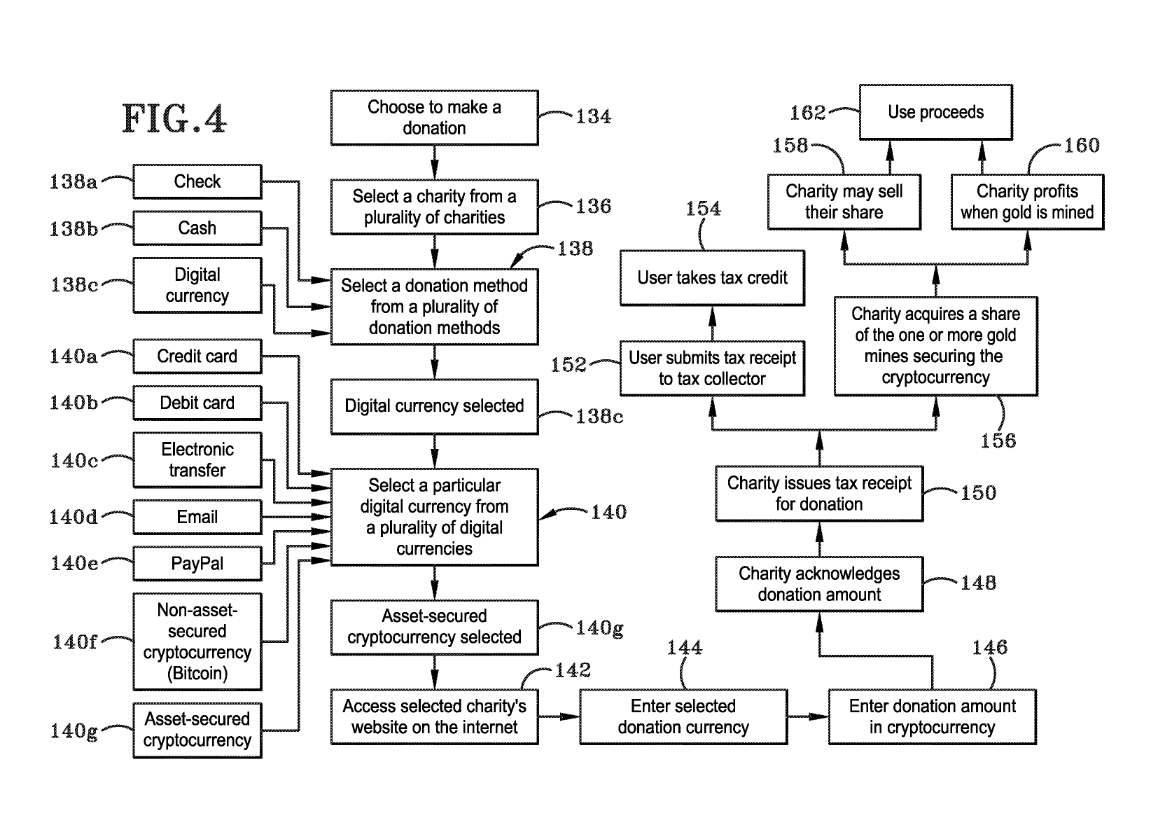

A method of making a donation 132 using cryptocurrency 110 is illustrated in FIG. 4. In a first step 134 a user 114 (FIG. 2) decides to make a charitable donation. In a second step 136, the user selects a single charity from a plurality of possible charities. In a third step 138, the user then selects a donation method from a plurality of possible donation methods. The plurality of donation methods may include but is not limited to, sending a paper check 138a, donating cash 138b, and using a digital currency 138c donated over the Internet. In the illustrated example, the user selects the donation method that involves utilizing a digital currency 138c to make the donation.

In a next step 140, the user selects a particular digital currency from a plurality of digital currencies. The plurality of digital currencies may include but is not limited to making a credit card donation 140a, making a debit card donation 140b, transferring money electronically from a bank checking or savings account 140c, making an email transfer 140d, using PayPal® or similar non-encrypted digital currencies 140e, selecting a non-asset-secured cryptocurrency such as Bitcoin 140f. In the illustrated method, the user selects to donate to the selected charity using the real-world asset-backed cryptocurrency 110. This selection is step 140g in FIG. 4.

The user 114 (FIG. 2) will then use their computing device 116, in a next step 142, to access the charity's website. In a next step 144, the user 114 will select the donation currency off a list provided on the website and will most particularly select real world asset-backed cryptocurrency 110. The user will enter the donation amount of the cryptocurrency 110 in the next step 146. The charity's website will, a next step 148, acknowledge the donation and will issue a tax receipt 150. The tax receipt may be generated and made immediately available to the user or may be emailed or mailed to the user.

In a next step 152, the user will present their tax receipt to their income tax collection authority with a tax return and will take a tax deduction from their income in a final step 154 for the user.

In a further step 156, the charity will acquire a share of the one or more gold mines that secure cryptocurrency 110. Charity 156 may then decide to take one or two courses of action. In a first course of action identified by the reference number 158 the charity may sell their share of the one or more gold mines. In a second course of action, identified by the reference number 80, the charity may hold onto their share in the one or more gold mines and will profit when the buried gold 104 is extracted and sold at the increased price. In either course of action, the charity will come to own proceeds (i.e., money) that may then be used in a final step 162 where the charity utilizes those proceeds to perform the work of the charity.

While the new cryptocurrency has been disclosed as being used to make charitable donations, it will be understood that the new cryptocurrency may, instead, be used to purchase goods or services. A method of paying for a good or service according to the present disclosure follows the steps set out above for making a donation but diverts from that method in that instead of making a donation using the units of cryptocurrency, the user may, instead purchase a good or a service from one of a business and an organization using the cryptocurrency to pay for the good or service. As such the method includes providing a cryptocurrency; backing the cryptocurrency with real world assets; and paying the business or the organization for the purchase good or purchase service utilizing a quantity of units of the cryptocurrency. The step of backing includes backing the cryptocurrency with a publically traded commodity. The step of backing may include backing the cryptocurrency with a precious metal asset. The precious metal asset may be gold assets, in particular gold that is not yet mined and is currently buried underground. The method may further include verifying a value of the buried gold. The step of verifying includes using an independent third party to independently verify the value the buried gold. The method may further include assigning a value to a unit of the cryptocurrency based on the independent verification of the value of the buried gold and gaining, on a part of the business or the organization, a share in the buried gold assets. The method may further include determining the share in the buried gold assets based on the quantity of units of cryptocurrency paid to the business or the organization.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A method of making a donation to a charity comprising steps of:
providing a cryptocurrency; and
backing the cryptocurrency with real world assets.

2. The method according to claim 1, wherein the step of backing includes backing the cryptocurrency with a publically traded commodity.

3. The method according to claim 1, wherein the step of backing includes backing the cryptocurrency with a precious metal asset.

4. The method according to claim 3, wherein the step of backing the cryptocurrency with a precious metal asset includes backing the cryptocurrency with gold assets.

5. The method according to claim 4, wherein the step of backing the cryptocurrency with gold assets includes backing the cryptocurrency with gold that is not yet mined and is currently buried underground.

6. The method according to claim 5, further comprising:
verifying a value of the buried gold.

7. The method according to claim 6, wherein the step of verifying includes using an independent third party to independently verify the value the buried gold.

8. The method according to claim 7, further comprising:
assigning a value to a unit of the cryptocurrency based on the independent verification of the value of the buried gold.

9. The method according to claim 8, further comprising:
donating a quantity of units of the cryptocurrency to one of a non-profit organization or a charitable organization.

10. The method according to claim 9, further comprising:
issuing, by the non-profit organization or the charitable organization, a tax deduction receipt for the donated quantity of units of cryptocurrency.

11. The method according to claim 10, further comprising:
presenting, by a donor of the quantity of units of cryptocurrency, the tax deduction receipt to a tax collection office of a national government of the donor when the donor is paying income tax.

12. The method according to claim 11, further comprising:
applying a tax deduction provided by the tax deduction receipt to the donor's income tax.

13. The method according to claim 12, further comprising:
gaining, on a part of the non-profit organization or the charitable organization, a share in the buried gold assets.

14. The method according to claim 13, further comprising:
determining the share in the buried gold assets based on the quantity of units of cryptocurrency donated to the non-profit organization or the charitable organization.

15. The method according to claim 13, further comprising:
selling the non-profit organization's share or the charitable organization's share of the buried gold assets.

16. The method according to claim 15, further comprising:
utilizing proceeds of a sale of the non-profit organization's share or the charitable organization's share of the buried gold assets for work performed by the non-profit organization or the charitable organization.

17. The method of claim 13, further comprising:
mining and processing the gold;
selling the mined and processed gold;
realizing a profit from the sold processed gold;
taking the non-profit organization's share or the charitable organization's share of the profit; and
utilizing the non-profit organization's share or the charitable organization's share of the profit for work performed by the non-profit organization or the charitable organization.

18. A method of paying for a good or service comprising:
purchasing a good or a service from one of a business and an organization;
providing a cryptocurrency;
backing the cryptocurrency with real world assets; and
paying the business or the organization for the purchase good or purchase service utilizing a quantity of units of the cryptocurrency.

19. The method according to claim 18, wherein the step of backing includes backing the cryptocurrency with a publically traded commodity.

20. The method according to claim 18, wherein the step of backing includes backing the cryptocurrency with a precious metal asset.

21. The method according to claim 20, wherein the step of backing the cryptocurrency with a precious metal asset includes backing the cryptocurrency with gold assets.

22. The method according to claim 21, wherein the step of backing the cryptocurrency with gold assets includes backing the cryptocurrency with gold that is not yet mined and is currently buried underground.

23. The method according to claim 22, further comprising:
verifying a value of the buried gold.

24. The method according to 23, wherein the step of verifying includes using an independent third party to independently verify the value the buried gold.

25. The method according to claim 24 further comprising:
assigning a value to a unit of the cryptocurrency based on the independent verification of the value of the buried gold.

26. The method according to claim 18, further comprising:
gaining, on a part of the business or the organization, a share in the buried gold.

27. The method according to claim 26, further comprising:
determining the share in the buried gold based on the quantity of units of cryptocurrency paid to the business or the organization.
